(19) United States
(12) Patent Application Publication
(10) Pub. No.: US 2008/0250067 A1
(43) Pub. Date: Oct. 9, 2008

(54) SYSTEM AND METHOD FOR SELECTIVELY IDENTIFYING MEDIA ITEMS FOR PLAY BASED ON A RECOMMENDER PLAYLIST

(75) Inventor: Hugh Svendsen, Chapel Hill, NC (US)

Correspondence Address: CONCERT TECHNOLOGY AND WITHROW & TERRANOVA, 100 REGENCY FOREST DRIVE , SUITE 160, CARY, NC, 27518, US

(73) Assignee: Concert Technology Corporation, Durham, NC (US)

(21) Appl. No.: 11/697,360

(22) Filed: Apr. 6, 2007

(51) Int. Cl. G06F 17/30

(52) U.S. Cl. 707/104.1; 707/E17.009

(57) ABSTRACT

A system and method for controlling media item recommendations received by a user based on the rendering of a user's pre-established recommender playlist. The recommender playlist is a list of identifiers that identify recommenders in the user's social network and a filter rule(s) associated with each recommender included in the recommender playlist. The filter rule(s) may be a rule associated with recommender's media items of the recommender. The user is able to control which media items from the recommender's media items of the recommender will be actually received by selecting the desired filter rule(s) for each of the recommenders in the user's recommender playlist. After the user establishes the recommender playlist and the user desires to actually receive recommendations from a recommender, the user renders the recommender playlist to receive a playlist consisting of the recommender's media items as filtered using filter rule(s) established by the user in the recommender playlist.

### FIELD OF THE INVENTION

The present invention relates to a system and method for selectively identifying media items for a user's play based on the rendering of a user's recommender playlist comprising one or more media item recommenders and one or more rules associated with the recommenders.

### BACKGROUND OF THE INVENTION

In recent years, there has been an enormous increase in the amount of digital media available online. Services, such as Apple's itunes® for example, enable users to legally purchase and download music. Other services, such as Yahoo!® Music Unlimited and RealNetwork's Rhapsody® for example, provide access to millions of songs for a monthly subscription fee. YouTube® provides users access to video media. As a result, media items have become much more accessible to consumers worldwide. Due to the large amount of the accessible digital media, recommendation technologies are emerging as an important enabler to assist users in identifying and navigating large databases of available media. Recommendations are useful to assist users in navigating large databases of media items to identify and select items of interest for usage and/or play.

Recommendations may be programmatically-generated by a company based on the user's predefined preferences and profiles. Or, recommendations may be provided by other users in a social network, referred to as peers. Social networks provide an important environment for mining peer media recommendations. A peer recommendation may be generated based on a peer's media item collection, play activity and/or play history. The user's predefined preferences and profiles, as well as the profiles of a peer recommender, may govern the selection and provision of peer media recommendations.

However, as the number of peer recommenders increase in a user's social network, the number of media item recommendations increase as a result. Eventually, the number of media item recommendations may become significant enough to make it difficult for the user to effectively navigate and select media items of interest for usage and/or play. To address this issue, approaches have been developed to control media item recommendations for the user. These approaches are directed to applying filters to the media item recommendations.

The media item recommendation filters in these prior approaches are identically applied to all the media item recommendations from all identified recommenders. In other words, the media item recommendation filter is not adjusted or adapted to different media item recommendations from different identified recommenders. For example, the same genre filter may be applied to all of the media item recommendations from all of the recommenders.

In addition, the user has no control over the selection or provision of the media item recommendations. With the prior approaches, the user is relegated to receiving media item recommendations selected and provided by the recommender, and then applying the filter or having the filter applied to all of the received media item recommendations. In other words, the recommender, and not the user, controls the selection and provision of media item recommendations. The user may desire to have more control over the selection and provision of the media item recommendations.

### SUMMARY OF THE INVENTION

The present invention is a system and method for controlling media item recommendations received by a user based on the rendering of a user's pre-established recommender playlist. The recommender playlist is a list of identifiers that identify recommenders in the user's social network and a filter rule(s) associated with each recommender included in the recommender playlist. The filter rule(s) may be a rule to be applied to recommender's media items. The recommender's media items may be media items in the recommender's media item collection, the recommender's play history, or any other media item related information, including information based on a recommender's profile. The user is able to control which media items from the recommender's media items will be actually received by selecting the desired filter rule(s) for each of the recommenders in the user's recommender playlist. Later, after the user establishes the recommender playlist and the user desires to actually receive recommendations from a recommender, the user renders the recommender playlist. In response, the media item recommendations of the recommender are selected by application of the filter rule(s) to the recommender's media items of the recommender stored in the user's recommender playlist. The user receives a playlist consisting of the media items filtered from the recommender's media items using the filter rule(s) established by the user in the recommender playlist. In this manner, the user can selectively control which media items are actually received from recommenders in the user's social network on a per recommender basis.

In this regard, the user first generates the recommender playlist. The user receives a list of recommenders on the user's social network and the recommenders' respective identities. The user decides which recommenders to include in the recommender playlist and one or more filter rules for each recommender included in the recommender playlist. The user may establish a different filter rule(s) for each of the recommenders in the recommender playlist on an individual recommender basis for maximum flexibility and control resolution. When the user renders the recommender playlist, the one or more filter rules may be applied to the recommender's media items of the recommender to control the selection of the media item recommendations sent to the user. The user may then play the media item recommendations of the recommender. The user may choose to render all recommenders in the recommender playlist, where the rendering process may continue for each recommender by their order of inclusion in the recommender playlist. Alternatively, the user may only select specific recommenders out of the recommender playlist for rendering without rendering the entire recommender playlist.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a user-server system, wherein the media item recommendations sent to a user are controlled by rendering the user's recommender playlist;

FIG. 2 is a block diagram of an exemplary user accounts database according to one embodiment of the present invention;

FIG. 3 is a block diagram of an exemplary recommender playlist according to one embodiment of the present invention;

FIG. 4 is a flow chart illustrating the process of establishing a recommender playlist by identifying and selecting recommenders to include in the recommender playlist and applying one or more filter rules for the recommenders in the recommender playlist;

FIG. 5 is a flow chart illustrating the process for generating and rendering a user's recommender playlist according to one embodiment of the present invention;

FIG. 6 illustrates an exemplary communications flow diagram between the server and user devices for assigning and sending unique identifiers for user devices, and storing related play histories to develop a playlist when a recommender playlist is rendered;

FIGS. 7A and 7B illustrate an exemplary communications flow diagram between the central server, a user device, and a subscription service, wherein the server renders a recommender playlist to select media item recommendations for a user;

FIG. 8 illustrates an exemplary graphical user interface (GUI) for establishing a recommender playlist:

FIG. 9 illustrates an exemplary GUI of a recommender playlist according to one embodiment of the present invention;

FIG. 10 is a block diagram illustrating more detail regarding components on the server of FIG. 1 according to one embodiment of the present invention; and

FIG. 11 is a block diagram illustrating more detail regarding components of the user device of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is a system and method for controlling media item recommendations received by a user based on the rendering of a user's pre-established recommender playlist. The recommender playlist is a list of identifiers that identify recommenders in the user's social network and a filter rule(s) associated with each recommender included in the recommender playlist. The filter rule(s) may be a rule to be applied to recommender's media items. The user is able to control which media items from the recommender's media items will be actually received by selecting the desired filter rule(s) for each of the recommenders in the user's recommender playlist. Later, after the user establishes the recommender playlist and the user desires to actually receive recommendations from a recommender, the user renders the recommender playlist. In response, the media item recommendations of the recommender are selected by application of the filter rule(s) to the recommender's media items stored in the user's recommender playlist. The user receives a playlist consisting of the media items as filtered from the recommender's media items using the filter rule(s) established by the user in the recommender playlist. In this manner, the user can selectively control which media items are actually received from recommenders in the user's social network on a per recommender basis.

In this regard, the user first generates the recommender playlist. The user receives a list of recommenders on the user's social network and the recommenders' respective identities. The user decides which recommenders to include in the recommender playlist and one or more filter rules for each recommender included in the recommender playlist. The user may establish a different filter rule(s) for each of the recommenders in the recommender playlist on an individual recommender basis for maximum flexibility and control resolution. When the user renders the recommender playlist, the one or more filter rules may be applied to the recommender's media items to control the selection of the media item recommendations sent to the user. The user may then play the media item recommendations of the recommender. The user may choose to render all recommenders in the recommender playlist, where the rendering process may continue for each recommender by their order of inclusion in the recommender playlist. Alternatively, the user may only select specific recommenders out of the recommender playlist for rendering without rendering the entire recommender playlist.

For purposes of explaining the present invention and providing differentiation among the users in the system, the user receiving the media item recommendations will continue to be referred to herein as the “user.” The users from whose recommender's media items the media item recommendations are selected based on one or more rules established in a recommender playlist will be referred to herein as a “recommender” or “recommenders.” Accordingly, a recommender playlist refers to a playlist of the user comprised of recommenders and the one or more filter rules associated with the recommender on the recommender playlist. Additionally, it should be understood that the term “media item” refers to and means any type of audio or visual display or presentation, including, but not limited to songs, other musical or aural presentations, movies, and other visual, graphical, and textual presentations.

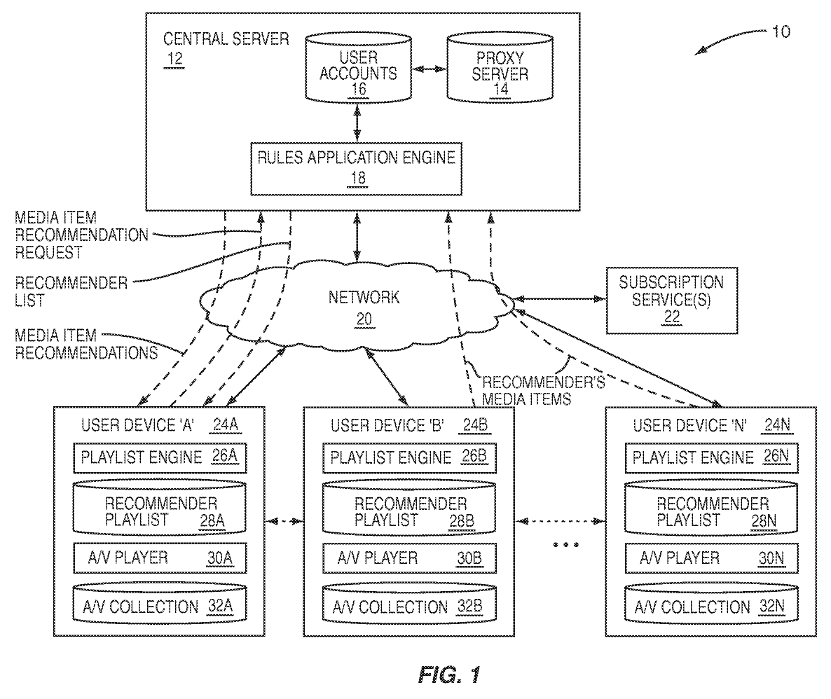

FIG. 1 illustrates an exemplary system 10 for generating and 30 rendering a recommender playlist in accordance with the present invention.

In this example, the system 10 has a central server 12 that maintains a record of a user's various media collections. The central server 12 manages the flow of information and services provided to users of the system 10, including but not limited to registering new user accounts, assigning unique identifiers for each user registered; storing user profiles, preferences, play histories, and other information about the user and the user's media collections. The central server 12 is also capable of generating and managing the flow of media item recommendations to users, such as through the rendering of a recommender playlist as will be discussed through the remainder of this application. In this example, the central server 12 operates in a user-server relationship with users. However, it should be noted that the present invention may be implemented in a peer-to-peer configuration where features of the central server 12 are provided by either a proxy server 14 or a “super” peer device. The central server 12, in whatever form provided, provides media-based services to the user. Note that the central server 12 also may be implemented as a number of servers operating in a collaborative fashion.

The central server 12 may be comprised of a database of user accounts 16 and a rules application engine 18. The user accounts 16 may contain a record of accounts for each user known to the central server 12 and information concerning the aspects of the user's activities on the system 10. The rules application engine 18 is a program, algorithm, or control mechanism that applies filter rules provided by the user, via the user's recommender playlist, to generate the media item recommendations. The rules application engine 18 may also send media item recommendations to the user in response to rendering the user's recommender playlist in total or for a particular recommender.

The central server 12 is also able to communicate with other devices and systems over a network 20. The network 20 may be any private network or distributed public network such as, but not limited to, the Internet. The central server 12 may communicate over the network 20 with one or more subscription services 22 for accessing media items for downloading. Some media items requested may not be stored locally in the central server 12, but rather are obtained from subscription service(s) 22 only when needed or on-demand.

The system 10 also includes a number of user devices 24A-24N which are optionally connected to the central server 12, the subscription service(s) 22, and each other via the network 20. The user devices 24 can be both users and recommenders as defined above. In other words, a user device 24 may act as a user by generating and rendering a recommender playlist. The user device 24 may also act as a recommender when another user identifies the recommender in his respective recommender playlist. Also note that while three user devices 24A, 24B, 24N are illustrated, the present invention may be used with any number of two or more user devices.

The user devices 24 may be any type of computing device that is capable of performing communications over the network 20 to reach the central server 12 and other user devices 24. Examples of user devices 24 include, but are not limited to, home computers; computers at work; laptop computers; wireless portable media player (PMP) devices; hand-held computer devices, such as personal digital assistants (PDA) with remote communication capabilities; and the like. A web browser (not shown) may be included within each user device 24 to provide an interface for the user for Internet-based communications, including those with the central server 12.

Each user device 24 that desires to access and receive the services of the central server 12 may first register with the central server 12. Registering with the central server 12 may include providing the central server 12 with any appropriate information from which a user profile may be developed by the central server 12 and recorded and stored in the user accounts 16. The central server 12 also may assign a unique identifier, such as in the form of a user id or nickname for example, for the user which also may be stored in the user accounts 16 and used to designate the particular user and relate to the information of that user in the user accounts 16. In this manner, the central server 12 can distinguish and provide services to users distinctively based on the unique identifier. In addition, each user device 24, acting as a recommender, may automatically send to the central server 12 the recommender's media items. This is so a user's recommender playlist may be properly rendered as will be described in more detail below in this application. The recommender's media items including the media item collection and play history of each user device 24, acting as a recommender, are stored in the user account 16 assigned to the recommender based on the recommender's unique identifier in the system 10.

The user device 24 may also contain a playlist engine 26. The playlist engine 26 is a program, algorithm, or control mechanism that allows a user to generate a recommender playlist 28 and render the recommender playlist 28 to receive media item recommendations from recommenders established in the recommender playlist 28. The recommender playlist 28 includes the user's desired list of recommenders by recommender identifier from the recommender list, and one or more pre-established filter rules for each recommender. The filter rules are applied to the recommender's media items to select media item recommendations sent to the user when the recommender playlist is rendered by the playlist engine 26.

The playlist engine 26 may render the recommender playlist 28 when instructed by the user. When the playlist engine 26 renders the recommender playlist 28, the user's recommender playlist 28 is accessed. As illustrated by the communication between user device ‘A’ 24A and the central server 12 in FIG. 1, the user device 24 sends the recommender identifier of the recommender and the user pre-established rule or rules associated with that recommender, both of which are stored in the recommender playlist 28, to the central server 12. In return as also illustrated in FIG. 1, the user device 24 receives from the central server 12 media item recommendations, which are selected by the central server 12 as a result of its rules application engine 18 applying the user pre-established filter rule or rules associated with the recommender to the received recommender's media items. The media item recommendations received by the user as a result of rendering the recommender playlist 28 can be selected and played by the user device 24 as desired by the user.

As previously discussed, the user has the option of rendering just one recommender stored in the user's recommender playlist 28. If this option is chosen, the selected recommender will be rendered and media item recommendations based on the recommender's media items meeting the pre-established filter rules will be received by the user. If the user desires to render the entire recommender playlist 28, meaning that all recommenders and their associated rules are sent by the user device 24 to the central server 12, the rendering process will continue with the user device 24 sending the recommender identifier of another recommender and the pre-established filter rules for the recommender in the order in which the recommenders are positioned on the recommender playlist until completed.

The user device 24 also typically contains an audio/video (AN) player 30 that allows the user to use or play back any media item desired. Examples of A/V players 30 include but are not limited to Apple® itunes®, Apple® iPOD®, and the like. Media items rendered from the recommender playlist 28 for use and/or play include those stored locally at the user device 24 in a user's A/V collection 32, and/or any media item accessed from the central server 12, a recommender's user device, the subscription service(s) 22, and/or any other system or device accessible by or coupled to the network 20.

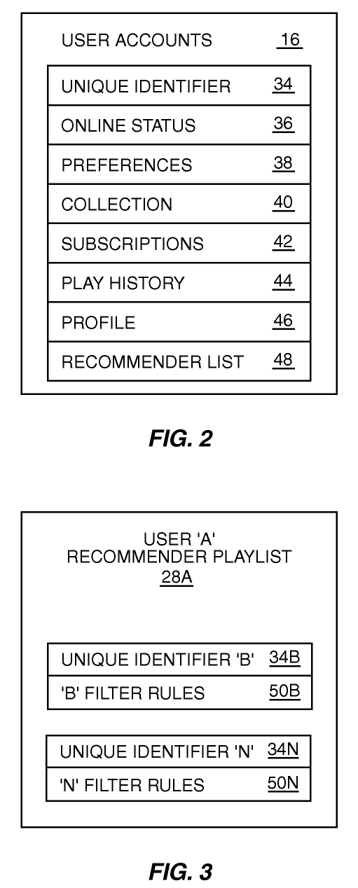

FIG. 2 is a block diagram of an exemplary user account 16 for a user registered on the system 10. In one embodiment of the present invention, the user account 16 may be stored on the central server 12. The user account 16 may store a record of the certain information concerning the user, the user's media item collection, and the user's activities involving media items. The central server 12 may assign a unique identifier 34 when the user registers with the system 10. The unique identifier 34 may be stored in the user account 16 and used to identify a user or recommender. In this manner, the central server 12 can distinguish between users and recommenders when providing media related services, including media item recommendations initiated by rendering a recommender playlist as provided by the present invention. The unique identifier 34 may also be used to associate the other information in the user account 16 with that particular user and the particular user device 24 and whether that user device 24 is able to communicate with the system 10 by the online status 36.

The user account 16 may also contain information regarding the user's particular media preferences 38. The user's media preferences 38 may relate to the different likes and dislikes of the user based on certain identified media categories. The media categories, for example, may be genre, artist, date of release of the media item, and others. Also, the user account 16 may have a record of the user's collection of media items 40, and any subscriptions 42 the user may have with subscription service(s) 22. The user account 16 also records the user's play history 44. The user's play history 44 is a time-stamped record of each media item played by the user. The preferences 38, collection 40, play history 44, and information provided by the user at the time of registration may be used to develop a profile 46 of the user. Additionally, the profile 46 may include a statistical compilation of the aforementioned user information.

The user account 16 may also contain a recommender list 48. The recommender list 48 is a list of the other users registered on the system 10 that a user has designated to be within the user's social network for receiving media item recommendations. The recommender list 48 identifies users selected to be a recommender according to their respective unique identifiers 34. As discussed above, the users on the system 10 can be recommenders to other users. The central server 12 may send the recommender list 48 to the user device 24 to advise a user of the recommenders registered on the system 10. This allows a user to control how media item recommendations are received by providing the unique identifier of desired recommenders in the user's recommender playlist 28.

FIG. 3 is a block diagram of an exemplary recommender playlist 28 established by a user and stored on the user device 24. The user establishes the recommender playlist 28 by selecting recommenders among a received recommender list 48 from the central server 12. The user selects the recommenders from which the user desires to receive media item recommendations by providing the unique identifier of the recommender, as provided in the recommender list 48, in the user's recommender playlist 28. The user then inputs information regarding one or more filter rules 50 for each recommender in the recommender playlist 28. The playlist engine 26 receives the user's desired recommenders and associated filter rules and generates the user's recommender playlist 28.

As an example of a user establishing entries into their recommender playlist 28, FIG. 3 shows the recommender playlist 28A established by User ‘A’. The unique identifiers 34B and 34N of two recommenders, User ‘B’ and User ‘N’, are selected by the user for receipt of media item recommendations. These unique identifiers 34B, 34N are listed in the recommender playlist 28A. Based on the information from User ‘A’ 24A, the playlist engine 26A positions the unique identifiers 34B, 34N representing recommenders ‘B’ and ‘N’ first and second, respectively, in the recommender playlist 28A. Also, the playlist engine 26A includes one more filter rules 50 established by User ‘A’ for each recommender ‘B’ and ‘N’. The playlist engine 26A associates the ‘B’ Filter Rules 50B with the unique identifier 34B of recommender ‘B’ and the ‘N’ Filter Rules 50N with unique identifier 34N of recommender ‘N’ in the recommender playlist 28A. If the user desires to select other recommenders from the recommender list 48 to include in their recommender playlist 28A, the playlist engine 26A includes the other user-selected recommenders 34, according to their unique identifiers 34, and their user-defined filter rule(s) 50 in the recommender playlist 28A of User ‘A’.

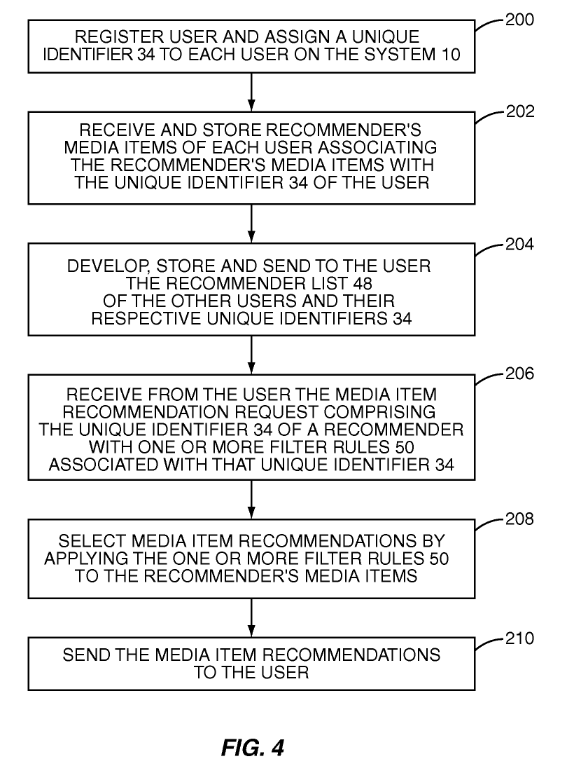

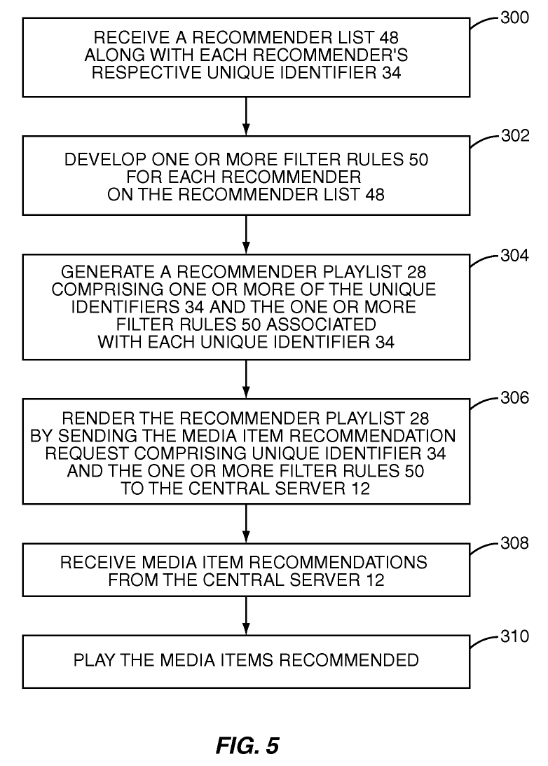

FIGS. 4 and 5 are flow charts illustrating an exemplary process of an embodiment of the present invention. FIG. 4 illustrates the portion of the process performed by the central server 12. FIG. 5 illustrates the portion of the process performed by the user device 24. Separate flow charts are used to provide a means for simplifying the illustration of the exemplary process. Although FIGS. 4 and 5 are separate flow charts, it should be understood that the portions of the process as illustrated in FIGS. 4 and 5 interact to illustrate the embodiment of the present invention.

FIG. 4 illustrates the portion of the exemplary process performed by the central server 12. FIG. 4 is provided to illustrate the interaction between the central server 12 and the user devices 24 on the system 10. FIG. 4 illustrates an exemplary process for assigning unique identifiers for the users, storing the users' play histories 44, developing and sending recommender lists 48, and selecting media item recommendations based on a user's recommender playlist 28. This portion of the process may also be performed by the proxy server 14, or by one of the user devices 24 if the system 10 is structured on a peer-to-peer basis.

The central server 12 registers the user and assigns the user a unique identifier 34. The unique identifier 34 may be assigned to each user that registers on the system 10 so that each user can be uniquely identified (step 200). A user account 16 is established for the user at the time of the registration. The unique identifier 34 is stored in the user account 16 and is used to identify the user with respect to any of the user's information or activities on the system 10. When a user registers on the system 10, the registration information may include information used to develop a profile 46 of the user. The registration information may also include information concerning the recommender's media items including the collection of media items 40, and play history 44. The profile 46 may also be stored in the user account 16 for the user. After registration, the play history 44 may be updated by receiving the play history 44 of each media item the user plays. The recommender's media items, including the updated play history 44, are received and stored in the user account 16 and associated with the unique identifier 34 of the user (step 202).

A recommender list 48 includes a list of recommenders that are registered on the system 10. The recommender list 48 includes the recommenders' respective unique identifiers 34 stored in their respective user accounts 16. The recommender list 48 is sent to users in the system 10 so that the users can identify recommenders from the recommender list 48 to include in their recommender playlist 28 (step 204). Note that some of the recommenders in the recommender list 48 may be automatically excluded based on information established in the user's profile 46. For example, a user may include in their user profile 46 to exclude any recommender from the recommender list 48 whose primary genre setting/like is “Rock.” Optionally, the user may also receive information about a recommender and the recommender's unique identifier 34 directly from the recommender.

The following is an example of a recommender list 48A which may be developed for and sent to User ‘A’ according to one embodiment of the present invention:

| Unique | |
|---|---|
| Identifier | Name |
| CT-B | Gene |
| CT-C | Mike |
| CT-D | Waymen |
| CT-E | Gary |
| CT-F | Jen |
| CT-G | Penelope |

In the above example, six (6) recommenders are included in the recommender list 48A. Nicknames have been established for each recommender and are associated with their unique identifier 34 so that user ‘A’ can identify any of these recommenders by name and the user device 24 and/or central server 12 can identify such recommender by their unique identifier 34A.

A media item recommendation request comprising a unique identifier 34 of the recommender and one or more filter rules 50 associated with that unique identifier 34 may be received from a user (step 206). The filter rules 50 are applied to the recommender's media items, as identified by the unique identifier 34, to select media item recommendations (step 208). Certain of the media items in the recommender's media items may be filtered by applying the filter rules 50 to the profile 46. The media items filtered from the recommender's media items are selected as media item recommendations and sent to the user (step 210).

FIG. 5 illustrates the portion of an exemplary process of one embodiment of the present invention performed by the user device 24. FIG. 5 is provided to illustrate a user device 24 in the position of a receiver of media item recommendations from other user devices 24 that are the recommenders. FIG. 5 illustrates an exemplary process for the user, via the user device 24, to establish filter rules to be applied to the play histories of selected recommenders on the system 10, generate the recommender playlist 28 comprising the filter rules and the associated recommenders, and render the recommender playlist 28.

The user receives the recommender list 48 with the identities of all or some of the recommenders with the recommenders' respective unique identifiers 34 (step 300). The user may develop one or more filter rules 50 for each of the recommenders on the recommender list 48 (step 302). A recommender playlist 28 comprising the unique identifiers 34 of the recommenders and the one or more filter rules 50 associated with the unique identifier 34 of each recommender is generated (step 304).

The one or more filter rules 50 may include, but not be limited to, for example, the following:
the media item currently being played by the recommender;
the last media item played by the recommender;
the media item most often played by the recommender based on a moving average over a specified period of time;
the specific media item selected from a list of a specified number of media items most played by the recommender over a certain period of time;
the media item is from a list of one or more media item recommendations explicitly provided by the recommender;
media items from the group of media items recently included in a collection of one of the one or more recommenders; or
any other media item as directed by the user.

The user may also determine the sequence of the recommenders on the recommender playlist 28 and the number of times a recommender is listed on the recommender playlist 28. Additionally, the user may input a filter rule 50 which causes a media item to be subject to a delay, for example, the current media item that the recommender will be playing in two hours.

The recommender playlist 28 is rendered by sending a media item recommendation request comprising one or more unique identifiers 34 with the one or more filter rules 50 associated with that unique identifier 34 to the central server 12, the proxy server 14, or the other user device 24 having the rules application engine 18 if the system 10 is a peer-to-peer system 10 (step 306). The recommender playlist 28 may be rendered by sending to the central server 12 the media item recommendation request comprising the unique identifier 34 with the one or more filter rules 50 sequentially beginning with the first unique identifier 34 selected and continuing sending unique identifiers 34 in the order that the unique identifiers 34 are positioned on the recommender playlist 28.

The media item recommendations developed by applying the filter rules 50 to the recommender's media items may be received from the central server 12, proxy server 14, or other user device 24 if the system 10 is a peer-to-peer system 10 (step 308). The media items on the media item recommendations may then be played by the user device 24 (step 310).

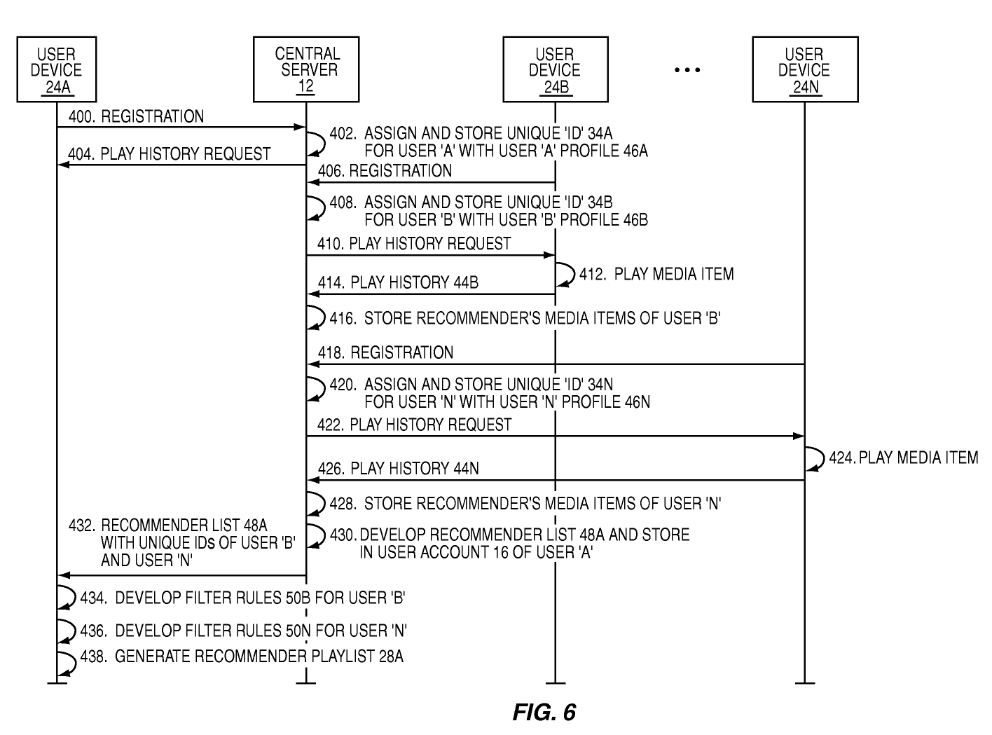

FIG. 6 illustrates an exemplary communication flow diagram between the user devices 24A, 24B, 24N and the central server 12. The purpose of this communication flow diagram is to illustrate the communication and interaction between the central server 12 and the user devices 24 and to illustrate the difference between a user device 24 performing as a user and a user device 24 performing as a recommender.

Each user in the system 10 that desires to participate with other users, such as being recommenders or providing media item recommendations to other users, will typically be registered so that the user can be assigned a unique identification in the system 10. In this regard, FIG. 6 first illustrates the communication flow for three users, User ‘A’, User ‘B’, and User ‘N’ to register with the central server 12.

As illustrated, User ‘A’ employing user device 24A sends a registration to the central server 12 (step 400). The central server 12 registers User ‘A’ and the user device 24A by assigning User ‘A’ a unique identifier 34A and storing the unique identifier 34A in a user account 16 for User ‘A’. The central server 12 also stores a profile 46A for User ‘A’ in the user account 16 of User ‘A’ (step 402). The central server 12 then sends a play history request to the user device 24A (step 404).

User ‘B’ employing user device 24B may also send a registration to the central server 12 (step 406). The central server 12 registers User ‘B’ and user device 24B by assigning User ‘B’ a unique identifier 34B and storing the unique identifier 34B in user account 16 for User ‘B’. The central server 12 also stores a profile 46B for User ‘B’ in the user account 16 of User ‘B’ (step 408). The central server 12 then sends a play history request to user device 24B (step 410). If user device 24B begins to play a media item (step 412), user device 24B sends a play history 44B to the central server 12 (step 414). The central server 12 stores the play history 44B in the user account 16 for User ‘B’ and updates the recommender's media items of User ‘B’ (step 416).

Lastly, User ‘N’ employing user device 24N may send a registration to the central server 12 (step 418). The central server 12 registers User ‘N’ and user device 24N by assigning User ‘N’ a unique identifier 34N and storing the unique identifier 34N in user account 16 for User ‘N’. The central server 12 also stores a profile 46N for User ‘N’ in the user account 16 of User ‘N’ (step 420). The central server 12 then sends a play history request to user device 24N (step 422). If user device 24N begins to play a media item (step 424), user device 24N sends a play history 44N to the central server 12 (step 426). The central server 12 stores the play history 44N in the user account 16 for User ‘N’ and updates the recommender's media items of User ‘N’. (step 428).

After users are registered, the central server 12 may develop a recommender list 48A comprising the unique identifiers of registered users, such as the unique identifiers 34B and 34N for User ‘B’ and User ‘N’, respectively. As illustrated, the central server 12 stores the recommender list 48A in the user account 16 for User ‘A’ (step 430). The central server 12 then sends the recommender list 48A to user device 24A (step 432). In this manner, User ‘A’ receives a recommender list 48A to select desired recommenders for media item recommendations as previously discussed. User ‘A’, utilizing user device 24A, establishes his recommender playlist 28A by establishing one or more filter rules 50B, 50N for User ‘B’ and User ‘N’, respectively (steps 434 and 436). The user device 24A generates the recommender playlist 28A comprising unique identifier 34B with filter rules 50B and unique identifier 34N with filter rules 5ON (step 438). At this point, User ‘A’ has established his recommender playlist 28A, wherein recommendations will be sent to User ‘A’ based on media items played by User ‘B’ and User ‘N’ that meet the respective filtering criteria established by User ‘A’ in the recommender playlist 28A.

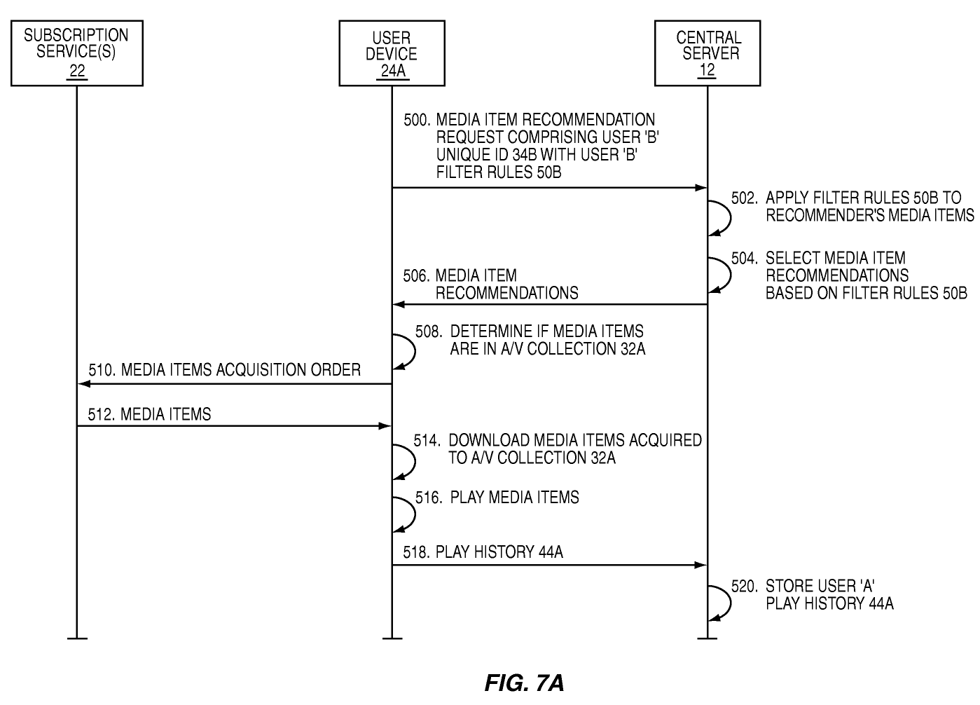

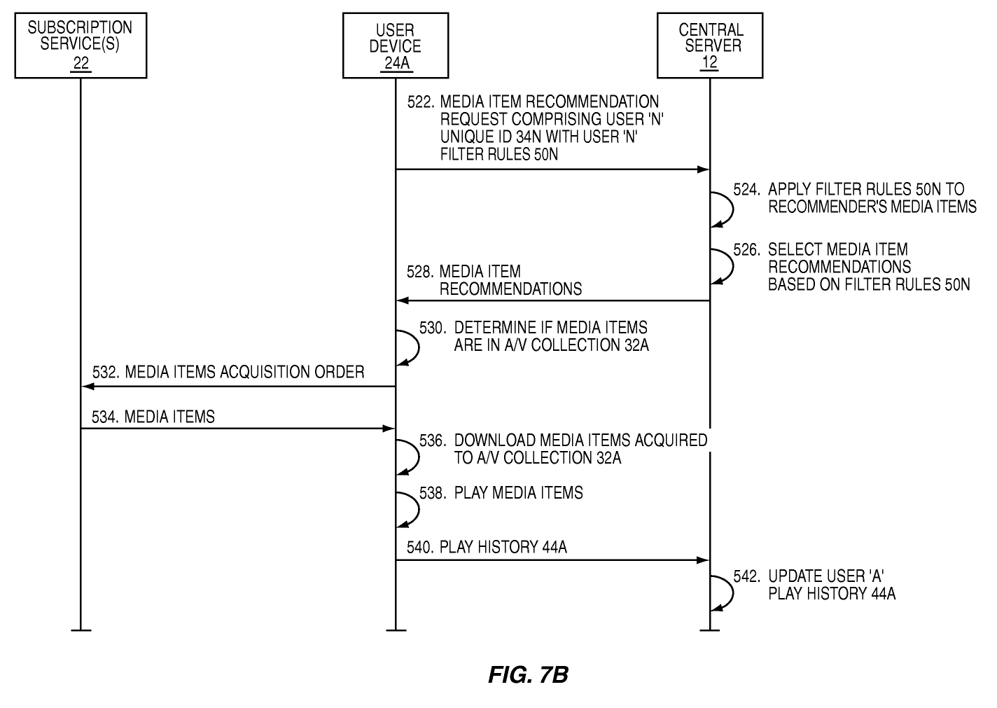

FIGS. 7A and 7B illustrate an exemplary communication flow diagram between the user device 24A, the central server 12, and the subscription service(s) 22. The purpose of FIGS. 7A and 7B is to illustrate the communication between the user device 24A, the central server 12 and subscription service(s) 22 involving the rendering of the recommender playlist 28A. In the illustrated example, ‘User B’ is rendered first. In this regard, the user device 24A sends to the central server 12 the media item recommendation request for User ‘B’ comprising the unique identifier 34B for User ‘B’ with one or more pre-established filter rules 50B associated with User ‘B’ (step 500). The filter rules 50B are applied to the recommender's media items of User ‘B’ (step 502) and media item recommendations are selected based on the application of the filter rules 50B (step 504). The central server 12 then sends the media item recommendations to user device 24A (step 506). The user device 24A determines if the media items in the media item recommendations are in the AN collection 32A (step 508).

If one or more media items are not in the A/V collection 32A, the user device 24A sends a media items acquisition order for those media items to the subscription service(s) 22 (step 510). The subscription service(s) 22 may contain the desired media items. ‘User A’ may have an account with the subscription service(s) 22 to have permission to receive such media items. The subscription service(s) 22 sends the media items ordered to the user device 24A (step 512), which are downloaded to the AN collection 32A (step 514). If the user device 24A plays any of the media items (step 516), a play history 44A is sent to the central server 12 (step 518). The User ‘A’ play history 44A is stored at the central server 12 in the user account 16 for User ‘A’ (step 520).

Next, User ‘N’ is rendered. As illustrated in FIG. 7B, the user device 24A sends to the central server 12 the media item recommendation request for User ‘N’ comprising the unique identifier 34N for User ‘N’ with pre-established filter rules 50N associated with User ‘N’ (step 522). The filter rules 50N are applied to the recommender's media items of User ‘N’ (step 524) and media item recommendations are selected based on filter rules 5ON (step 526). The central server 12 then sends the media item recommendations to user device 24A (step 528). The user device 24A determines if the media items in the media item recommendations are in the A/V collection 32A (step 530).

If one or more media items are not in the A/V collection 32A, the user device 24A sends a media items acquisition order for those media items to the subscription service(s) 22 (step 532). The subscription service(s) 22 then sends the media items ordered to the user device 24A (step 534) which downloads the media items to the AN collection 32A (step 536). If the user device 24A plays any of the media items (step 538) the play history 44A is sent to the central server 12 (step 540). The User ‘A’ play history 44A stored at the central server 12 in the user account 16 for User ‘A’ is updated (step 542).

In summary and to summarize the present invention by example, User ‘A’ has established a recommender playlist 28A based on recommender unique identifiers 34 among the recommender list 48. User ‘A’ has chosen to render his recommender playlist 28A to receive media item recommendations based on the play histories of User ‘B’ and User ‘N’. In this regard, the one or more filter rules 50 established by the User ‘A’ for User ‘B’ and User ‘N’ in the recommender playlist 28A are communicated to the central server 12. The central server 12 selects media item recommendations for User ‘A’ from the play histories of User ‘B’ and User ‘N’ by applying the filter criteria established by the user to the play histories of User ‘B’ and User ‘N’. The media item recommendations selected are sent by the central server 12 to User ‘A’. In this manner, User ‘A’ was able to effectively control media item recommendations received from other users rather than receiving all media item recommendations from these other users regardless of the recommender's media items.

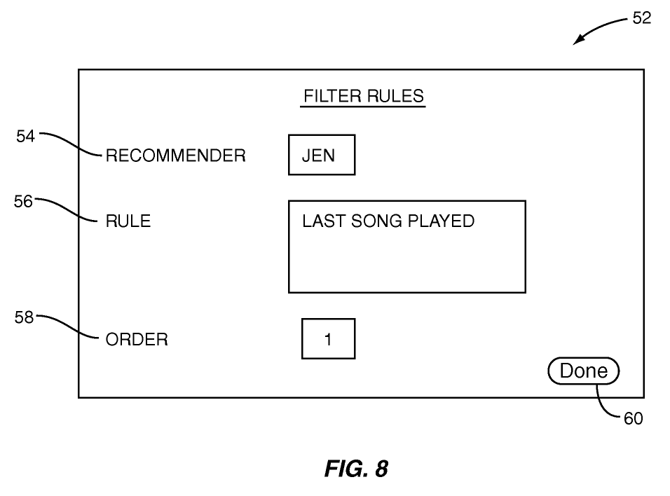

FIG. 8 illustrates an exemplary filter rules graphical user interface (GU I) 52 that may be executed by a user device that allows a user to provide the filter rules 50 for each recommender on the recommender list 48 when establishing their recommender playlist 28A. User ‘A’ provides the name or other identifying term for the recommender in the recommender field 54. In FIG. 8, User ‘A’ provided the name “Jen” in the recommender field 54. User ‘A’ then provides specific filter rules 50 in the filter rules field 56. In FIG. 8, User ‘A’ provided “last song played” in the filter rules field 56.

The filter rules GUI 52 also may include an order field 58 for selecting the order or position of the recommender on the recommender playlist 28. FIG. 8 shows that User ‘A’ selected “1” in the order field 58. Jen may then have the first position in the recommender playlist 28A. When the user has completed providing all of the information in the fields on the filter rules GUI 52, the user actuates a “Done” button 60. Upon actuation of the “Done” button 60, the information provided in the filter rules GUI 52 is be saved and recorded on the recommender playlist 28. The filter rules GUI 52 may then close. A similar filter rules GUI 52 may be used for the user to provide one or more filter rules 50 for all of the recommenders on the recommender list 48.

Optionally, if the user does not provide a filter rule 50 in filter rules field 56 prior to actuating the “Done” button 60, the playlist engine 28 automatically provides a default filter rule. The default filter rule may be any rule, for example, the “last played media item” of the recommender. Also, optionally, if the user does not select a position or order for the recommender, the playlist engine 28 defaults to positioning the recommender in the order in which the user opened the filter rules GUI 52 for that recommender.

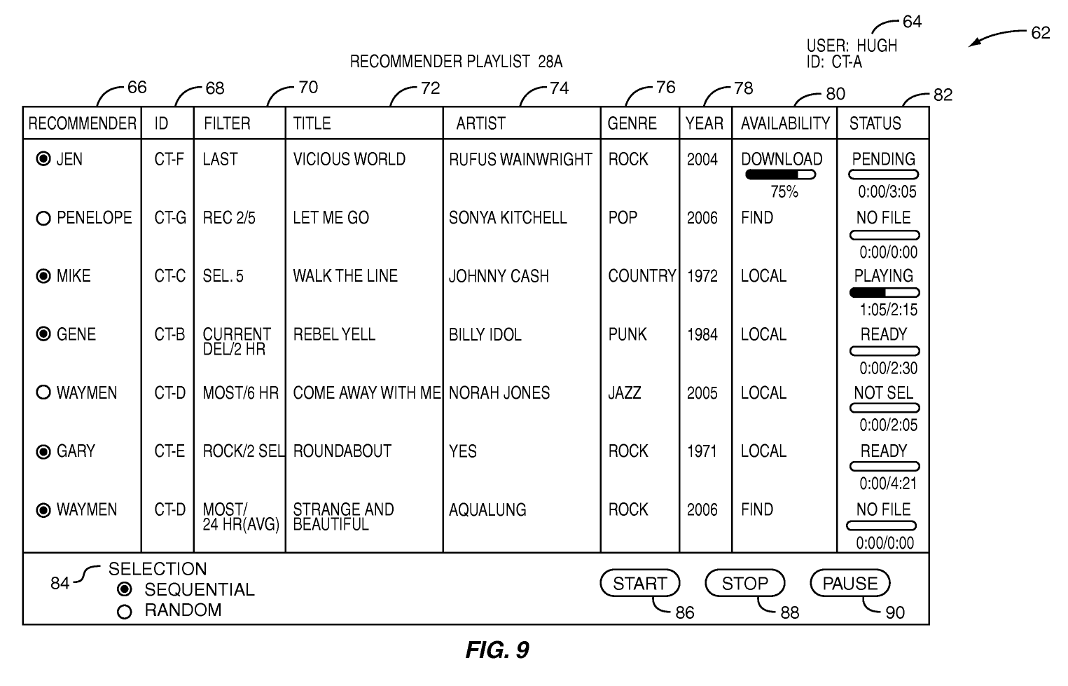

FIG. 9 illustrates an exemplary recommender playlist GUI 62 of the recommender playlist 28 populated with the information provided by the user and showing the activity of the media items resulting from the rendering of the recommender playlist 28. FIG. 9 shows the recommender playlist GUI 62 of User ‘A’ and indicates the name and unique identifier 64 for User ‘A’. The recommender playlist GUI 62 optionally may include several columns listing a variety of information related to the recommenders and the media items.

A recommender column 66 lists the recommenders in the order as selected by the user. A radio button for each recommender in the recommender column 66 is included. The user may select which recommender to include in a rendering by actuating the respective radio button. FIG. 9 shows that recommenders Jen, Mike, Gene, Gary, and a second input of Waymen have been selected, while Penelope and a first input of Waymen were not selected. An ID column 68 indicates the unique identifiers 34 for each respective recommender.

A filter column 70 indicates the pre-established filter rules 50 to be applied to each respective recommender. Optionally, the user, by actuating a filter rule 50 for a respective recommender shown in the filter column 70, may open the filter rules GUI 52 for that recommender. The user may then change any of the information on the filter rules GUI 52. Columns may be included to present information concerning the title 72, artist 74, genre 76 and year of release 78 of the media item resulting from the application of the filter rules 50. Additionally, a column indicating the availability 80 of the media item may be included. If the media item is filed in the user's AN collection 32, “local” may be shown under availability 80 by that respective recommender. If a media item was not in the AN collection 32, but was received and is in the process of being downloaded to the AN collection 32, “downloading” may appear with the progress of the downloading process shown on an indicator.

A status 82 column may also be included. This column shows the current status of each media item from each recommender on the recommender playlist GUI 62. The status 82 column indicates the media item currently playing with an indicator showing the amount of time that it has been playing compared to the total time of the media item. Optionally, status column 82 may also show other status situations. Status for a media item may be “ready” to be played, which means that it is located in the A/V collection 32. Status for a media item may also be “pending,” which may mean that it is in the process of being downloaded. If the media item is not included in the AN collection 32A, “No File” may be indicated. Also, if the user did not select that recommender, “Not Sel” may be indicated.

The user may also control the process by which the rendering of the recommender playlist 28 occurs. A selection control 84 allows the user to select whether the rendering is performed sequentially in the order as listed on the recommender playlist GUI 62 or by random. The user performs this by actuating radio buttons for “sequential” or “random.” When the user desires to start the rendering of the recommender playlist 28, the user actuates the “Start” button 86. Once rendering begins, the user may stop or pause the rendering process by actuating the “Stop” or “Pause” buttons 88 and 90, respectively.

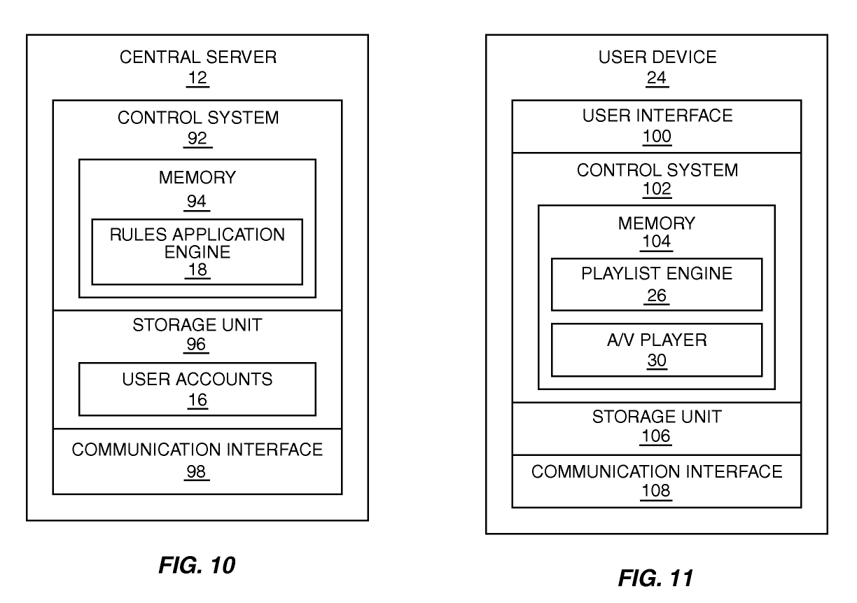

FIG. 10 is a block diagram illustrating more detail regarding exemplary components that may be provided by central server 12 of FIG. 1 to perform the present invention. In general, the central server 12 includes a control system 92 having associated memory 94. The rules application engine 18 is at least partially implemented in software and stored in the memory 94. The central server 12 also includes a storage unit 96 operating to store the user accounts 16 (FIG. 1). The storage unit 96 may be any number of digital storage devices such as, for example, one or more hard-disc drives, one or more memory cards, Random Access Memory (RAM), one or more external digital storage devices, or the like. The user accounts 16 may also be stored in the memory 94. A communication interface 98 may include a network interface allowing the central server 12 to be communicably coupled to the network 20 (FIG. 1).

FIG. 11 is another block diagram illustrating more detail regarding exemplary components that may be provided within the user device 24 of FIG. 1 to provide the present invention. In general, the user device 24 includes a user interface 100, which may include components such as a display, speakers, a user input device, and the like. The user device 24 also includes a control system 102 having associated memory 104. In this example, the playlist engine 26 and the A/V player 30 are at least partially implemented in software and stored in the memory 104. The user device 24 also includes a storage unit 106 operating to store the recommender playlist 28 and the A/V collection 32 (FIG. 1). The storage unit 106 may be any number of digital storage devices such as, for example, one or more hard-disc drives, one or more memory cards, RAM, one or more external digital storage devices, or the like. The recommender playlist 28 and the AN collection 32 may alternatively be stored in the memory 104. The user device 24 also includes a communication interface 108. The communication interface 108 may include a network interface communicatively coupling the user device 24 to the network 20 (FIG. 1).

Those skilled in the art will recognize improvements and modifications to the preferred embodiments of the present invention. All such improvements and modifications are considered within the scope of the concepts disclosed herein and the claims that follow.

What is claimed is:

1. A method of developing media item recommendations for a user, comprising the steps of:
receiving a media item recommendation request from a user comprising information from a recommender playlist comprising a list of one or more recommenders and one or more filter rules associated with each of the one or more recommenders;
applying the one or more filter rules associated with the one or more recommenders to recommender's media items of one of the one or more recommenders;
selecting media item recommendations based on the application of the one or more filter rules to the recommender's media items of the one of the one or more recommenders; and
sending the selected media item recommendations to the user.

2. The method of claim 1, wherein the one or more filter rules is a default filter rule.

3. The method of claim 1, further comprising the steps of:
registering one or more recommenders; and
assigning a unique identifier to each of the one or more recommenders.

4. The method of claim 3, further comprising receiving the recommender's media items from one or more recommenders.

5. The method of claim 3, further comprising the steps of:
developing a recommender list comprising the unique identifiers for one or more registered recommenders; and
sending the recommender list to the user.

6. The method of claim 5, wherein the information from the recommender playlist comprises the unique identifier of the recommender and one or more filter rules associated with the unique identifier.

7. The method of claim 1, wherein the one or more filter rules is a rule selected from the group consisting of: a currently playing media item of one of the one or more recommenders, the currently playing media item of one of the one or more recommenders subject to a delay, a most played media item by one of the one or more recommenders, a most played media item in a selected group of media items in the recommender's media items of one of the one or more recommenders, a most played media item of one of the one or more recommenders over a specified moving average time period, a specified media item from a group of media items selected by one of the one or more recommenders from the recommender's media items of the one of the one or more recommenders, and media items from the group of media items recently included in a collection of one of the one or more recommenders.

8. A system of developing media item recommendations for a user, comprising:
a server having a control system adapted to:
receive a media item recommendation request from a user comprising information from a recommender playlist comprising a list of one or more recommenders and one or more filter rules associated with each of the one or more recommenders;
apply the one or more filter rules associated with the one or more recommenders to recommender's media items of one of the one or more recommenders;
select media item recommendations based on the application of the one or more filter rules to the recommender's media items of the one of the one or more recommenders; and
send the selected media item recommendations to the user.

9. The system of claim 8, wherein the one or more filter rules is a default filter rule.

10. The system of claim 8, wherein the control system is further adapted to:
register one or more recommenders; and
assign a unique identifier to each of the one or more recommenders.

11. The system of claim 10, wherein the control system is further adapted to receive the recommender's media items from one or more recommenders.

12. The system of claim 10, wherein the control system is further adapted to:
develop a recommender list comprising the unique identifiers of one or more registered recommenders; and
send the recommender list to the user.

13. The system of claim 12, wherein the information from the recommender playlist comprises the unique identifier of the recommender and one or more filter rules associated with the unique identifier.

14. The system of claim 8, wherein the one or more filter rules is a rule selected from the group consisting of: a currently playing media item of one of the one or more recommenders, the currently playing media item of one of the one or more recommenders subject to a delay, a most played media item by one of the one or more recommenders, a most played media item in a selected group of media items in the recommender's media items of one of the one or more recommenders, a most played media item of one of the one or more recommenders over a specified moving average time period, a specified media item from a group of media items selected by one of the one or more recommenders from the recommender's media items of the one of the one or more recommenders, and media items from the group of media items recently included in a collection of one or more recommenders.

15. A method for establishing a recommender playlist for use in selecting media item recommendations by a server, comprising the steps of:
receiving a recommender list comprising unique identifiers for one or more recommenders in a social network; and
for the one or more recommenders in the recommender list:
receiving a selection for a recommender within the recommender list;
receiving a selection of one or more filter rules for the recommender; and
storing the unique identifier and the selected one or more filter rules for the recommender in a recommender playlist.

16. The method of claim 15 further comprising receiving the unique identifier of the recommender from the recommender.

17. The method of claim 15, further comprising sending to the server a media item recommendation request comprising the unique identifier and the one or more filters rules, wherein the one or more filter rules are applied to recommender's media items of the recommender.

18. The method of claim 17, further comprising receiving media item recommendations selected from the application of the one or more filter rules to the recommender's media items of the recommender.

19. The method of claim 18, further comprising playing the media items from the received media item recommendations.

20. A device for establishing a recommender playlist for use in selecting media item recommendations, comprising:
a control system adapted to:
receive a recommender list comprising unique identifiers for one or more recommenders in a social network; and
for the one or more recommenders in the recommender list:
receive a selection for a recommender within the recommender list;
receive a selection of one or more filter rules for the recommender; and
store the unique identifier and the selected one or more filter rules for the recommender in a recommender playlist.

21. The device of claim 20, wherein the control system is further adapted to receive the unique identifier of the recommender from the recommender.

22. The device of claim 20, wherein the control system is further adapted provide a media item recommendation request comprising the unique identifier and the one or more filters rules, wherein the one or more filter rules are applied to recommender's media items of the recommender identified by the unique identifier.

23. The device of claim 22, wherein the control system is further adapted to receive media item recommendations selected from the application of the one or more filter rules to the recommender's media items of the recommender.

24. The device of claim 23, wherein the control system is further adapted to play the media items from the media item recommendations.

25. A user interface generated by a control system executing on a microprocessor-based user device, comprising:
a filter rules screen for receiving one or more selections used to generate a recommender playlist, the filter rules screen comprising:
a recommender field for receiving the identity of a recommender associated with recommender's media items of the recommender;
a rule field for receiving one or more filter rules to be applied only to the recommender's media items of the recommender; and
an order field for receiving the position of the recommender in the recommender playlist.

26. The user interface of claim 25, wherein the filter rules screen further comprises a done button for receiving a command to save and record the information in the recommender field, the rule field, and the order field.

27. A user interface generated by a control system executing on a microprocessor-based user device, comprising:
a recommender playlist screen for rendering of a recommender playlist and tracking the status of media items, the recommender playlist screen comprising:
recommender columns, comprising:
a recommender column comprising a list of the recommenders and a radio button for each recommender, the radio button actionable by a user to select the recommender for rendering;
a unique identifier column comprising the unique identifiers of each of the recommenders; and
a filter column comprising the one or more filter rules associated with each of the recommenders wherein the one or more filter rules are applied to recommender's media items of the associated recommender to select media item recommendations of the recommender.

28. The user interface of claim 27, wherein the recommender columns further comprise a status column comprising information describing the current status of the media items from the media item recommendations, which information comprises an indication of the media items selected by the user and the media items currently playing.

29. The user interface of claim 27, wherein the recommender playlist screen further comprises a selection button comprising a sequential and a random selection for selecting by the user the method by which the recommender playlist is rendered.
